(19) United States
(12) Patent Application Publication
(10) Pub. No.: US 2023/0360549 A1
(43) Pub. Date: Nov. 9, 2023

(54) TECHNOLOGIES AND SERVICES TO DELIVER CUSTOMIZED AND RESPONSIVE LEARNING PATHWAYS AND RELATED SYSTEMS AND METHODS

(71) Applicant: Southern New Hampshire University, Manchester, NH (US)

(72) Inventors: Paul LeBlanc, Manchester, NH (US); Travis Willard, West Newburyport, MA (US); Gwendolyn Britton, Sunapee, NH (US); Rebecca Baker, McKinney, TX (US); Stephane Serre, Atlanta, GA (US)

(21) Appl. No.: 18/313,268

(22) Filed: May 5, 2023

Related U.S. Application Data
(60) Provisional application No. 63/339,288, filed on May 6, 2022.

(51) Int. Cl. G09B 5/02

(52) U.S. Cl. CPC G09B 5/02

(57) ABSTRACT

The present disclosure relates to systems and methods for delivering a customized and responsive learning pathway. In one embodiment, a profile service receives an objective related to a course of study, receives information to represent prior learning related to the course of study, and tracks progress related to the course of study. A prior learning assessment (PLA) engine conducts an assessment based on the prior learning related to the course of study, conducts a strength of fit analysis to align the assessment with a plurality of competencies and courses in a learning institution catalog and associated with the course of study, maps at least one of the plurality of competencies and courses to the assessment, and grants a credit for the at least one of the plurality of competencies and courses based on the assessment. A recommendation engine generates a customized and responsive learning pathway.

### RELATED APPLICATIONS

This application claims priority to U.S. Provisional Patent Application No. 63/339,288, filed May 6, 2022, and titled “TECHNOLOGIES AND SERVICES TO DELIVER CUSTOMIZED AND RESPONSIVE LEARNING PATHWAYS AND RELATED SYSTEMS AND METHODS,” which is hereby incorporated by reference in its entirety.

### TECHNICAL FIELD

This disclosure relates to systems, devices, and methods for the delivery of customized and responsive learning pathways. More particularly, but not exclusively, this disclosure relates to unified systems of technologies and services to deliver customized and responsive learning pathways at scale.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a flow diagram of a system and methods consistent with embodiments of the present disclosure.

FIG. 2 illustrates a diagram showing a connection between learning content, curriculum, skills and competencies, and workforce skills consistent with embodiments of the present disclosure.

FIG. 3 illustrates a diagram showing a connection between a knowledge graph and a skill graph consistent with embodiments of the present disclosure.

FIG. 4 illustrates a diagram showing a personalized path of learning for a specific job consistent with embodiments of the present disclosure.

FIG. 5 illustrates a functional block diagram showing information associated with a learning object consistent with embodiments of the present disclosure.

FIG. 6 illustrates a functional block diagram of a system to deliver a customized and responsive learning pathway consistent with embodiments of the present disclosure.

### DETAILED DESCRIPTION

The embodiments of the disclosure may be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need to be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Several aspects of the embodiments disclosed herein may be implemented as software modules or components. As used herein, a software module or component may include any type of computer instruction or computer-executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The non-transitory machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable media suitable for storing electronic instructions. In some embodiments, the computer or another electronic device may include a processing device such as a microprocessor, microcontroller, logic circuitry, or the like. The processing device may further include one or more special-purpose processing devices such as an application-specific interface circuit (ASIC), PAL, PLA, PLD, field programmable gate array (FPGA), or any other customizable or programmable device.

Embodiments of the present disclosure include an educational ecosystem that generates custom learning pathways to meet the needs of a student by recommending pathways by considering interests, experience, prior learning, and desired career or personal outcomes. Embodiments of the present disclosure may also meet the needs of the workplace by having institutions collaborate with employers and industry to upskill and prepare students for jobs that align with workplace needs. Embodiments of the present disclosure may allow students to reach their goals in an optimal timeline by aligning prior education and experience with individual competencies, courses, and other educational outcomes that can be easily stacked and sequenced to move a student toward their goal without repeating content for things they already know. Embodiments of the present disclosure also may provide needed resources to the institution's instructors and support staff, so they have a complete view of student profiles, pathways, progress, and behavior, offering prompts for students to take action notifications to staff for additional support.

In today's educational landscape, students are often overwhelmed by the sheer number of educational opportunities available to them, everything from on-the-job learning and training to institutional degrees. Students acknowledge they may need additional skills to advance in the workplace or their career, but may not know where to start, where they want to go, or how to get there quickly and affordably. They are frustrated by requirements to endure instruction on a competency or skill just for the sake of earning credit, especially if they already possess those skills and competencies.

Some embodiments of the present disclosure integrate several technologies into a unified end-to-end platform to deliver customized and responsive learning pathways based on the unique interests, personal goals, and prior education and experience of learners.

Embodiments of the present disclosure may additionally accelerate the timeline required for learners to reach their goal by maximizing the credits earned for prior learning and experience.

Additional embodiments of the present disclosure may offer guidance and recommendations on potential learning experiences, leveraging artificial intelligence and machine learning (AI/ML) against the learner's profile, prior education, prior experience, and goals.

Embodiments of the present disclosure may also align professional knowledge and achievements with academic standards and outcomes to ensure delivery of relevant learning experiences, reducing the duration between learning outcomes and employment opportunities.

Embodiments of the present disclosure may additionally enable rapid development of modularized, skill-based content and assessments that can be stacked and sequenced in various pathway configurations to meet the learning needs of all learners.

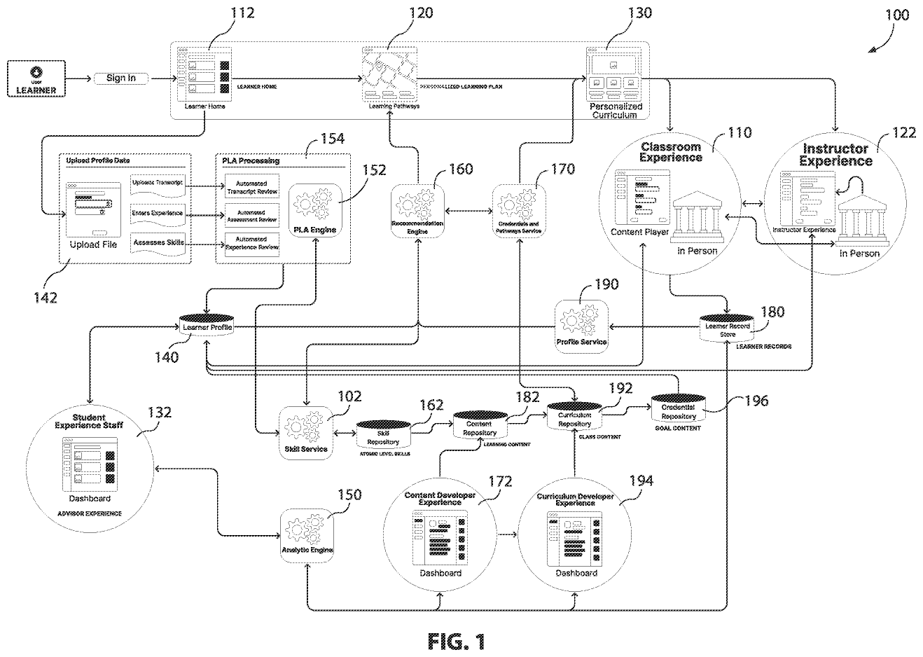

FIG. 1 illustrates a flow diagram of a system 100 consistent with embodiments of the present disclosure. System 100 may include interfaces for various users. The interface may include an interface for learners (e.g., students and/or prospective students) that may include a learner home 112, learning pathways 120, and personalized curriculum 130.

The learner home 112 may be configured for learners to create accounts on system 100 and sign in. Upon login, system 100 may present the learner with a consolidated view for all learner activities stored in a learner profile 140. From the learner home 112, learners can also access and update their learner profile 140.

Learning pathways 120 defines the number, specific type, and sequence of learning experiences needed to guide a learner to their goal. Learning pathways 120 may be generated by a recommendation engine 160 and suggest learning experiences (comprised of learning content objects, assessment objects, and modality), the suggestions being optimized by artificial intelligence (AI)(e.g., machine learning (ML)) based on learner attributes.

When progressing through their learning journey, learners may want to easily understand how their learning experiences, both past and present, are helping them to reach their goals. Previously earned credits may map to competencies and/or credits in pursuit of their current academic and/or career goals. Displaying this progress on the learning pathways 120 allows the learner to understand how this prior investment is used in pursuit of their goal. Learning pathways 120 may assure learners that they are on track, pursuing the correct learning experiences in the correct sequence, to achieve their goals. It may improve learner confidence and minimize a learner's time and financial investment.

Recommendation engine 160 may recommend several learning pathways 120, based on the learner's prior learning assessment (PLA), interests, and goals. A learner may select learning pathways 120 to pursue their goal. Each of the recommended learning pathways 120 may display metadata, including, but not limited to time to completion, cost, academic rigor, etc. Learning pathways 120 may provide learners with an easy-to-understand visualization of how their education, work experience, skills, and interests align with the learning experience(s) of an educational institution to achieve their goal.

A visual pathway may be formatted as a directed acyclic graph (DAG) of learning experiences mapped to a goal. The pathway visualizes the recommended sequence of learning experiences, aligned to competencies, as produced by recommendation engine 160. The pathway may visualize credentials and pathway options for learners from the credential and pathways service 170.

Learning pathways 120 may be adaptive and change as the learner makes progress toward and/or changes one or more of their goals. If the learner changes learning pathways 120 in the future, additional credentials and experiences are considered as recommendation engine 160 updates learning pathways 120. Progress on learning pathways 120 may be displayed in real time at the program level and may be updated as the inputs change. Learning pathways 120 allows for goals and achievements to be met along the way, granting learners with smaller credentials, such as badges or certificates along learning pathways 120.

Personalized curriculum 130 is the specific collection of learning experiences a learner engages in to complete the competencies and credits necessary to earn one or more credentials in learning pathways 120 that are aligned with their goal. The custom learning experiences that form personalized curriculum 130 can be delivered through virtual, in-person, and hybrid learning experiences.

Personalized curriculum 130 may be more precisely aligned with the learner's needs because it is aligned to skills and mapped to competencies that can be independently evaluated and assessed. By combining this approach with advanced diagnostics to assess learner knowledge and skill level throughout the learner journey, along with a robust system for evaluating and granting credit for prior learning via prior learning assessment (PLA) engine 152, system 100 may optimize the learner's path to each of their goals. For example, when presented with a typical course in the curriculum aligned to three competencies, a learner with prior knowledge, skills, and experience in that subject area may be granted credit for one or two of those competencies through PLA engine 152. The learner's course requirements may then be adjusted, so that the learner is only focused on learning and completing the necessary competencies and not spending time and money retreading content they have already completed. Without a personalized approach, learners may struggle to confidently understand and choose a learner experience that aligns properly with the learner's chosen program. When making these decisions, it may be important for learners to have an accurate and consistent presentation of information to focus on the goal with minimal frustration, time to completion, and cost. Accordingly, personalized curriculum 130 may communicate appropriate and aligned learning experience options to the learner.

The learner may easily access new or previously completed content from their learner dashboard. Personalized curriculum 130 may display learning content clearly and efficiently, without the need to switch sites. Additionally, personalized curriculum 130 that is delivered virtually may be displayed through a single virtual environment to streamline the learning experience. In view of the foregoing, personalized curriculum 130 may reduce duplication of learning content design and creation.

A learner may enter profile data, including, but not limited to, prior education and transcripts, work experience, and skills using learner onboarding 142.

The profile data entered by the learner through the learner onboarding 142 may be processed with PLA processing 154 (including a PLA engine 152). PLA engine 152 will process, analyze, and evaluate artifacts of an individual's prior learning and/or assertions of knowledge, skills, or experience to determine whether credit can be awarded. Using skills mapping and AI/ML, skill service 102 and PLA engine 152 may identify credentials that might be granted based on whether those instances of prior learning have been previously deemed worthy of academic credit or by conducting a strength of fit analysis to align the knowledge, skills, and competencies articulated in these instances of prior learning to those mapped competencies and courses in the learning institution's catalog. For similar but not exact matches, a PLA administrator may use this strength of fit analysis, along with additional research, to grant credit for competencies and/or course credit, if deemed appropriate. PLA engine 152 may monitor all updated decisions by the PLA administrator to continually update earned credentials for all learners affected by those decisions.

System 100 may leverage PLA information from linked open data sources, such as a credential registry, that maps to the learning institution skills and competencies in skill service 102 to identify potential matches. For example, by leveraging AI/ML for PLA processing 154 (including a PLA engine 152), system 100 may ingest PLA transcripts, articulation agreements, prior work experience and/or other documents from the learner profile 140, parse and extract relevant data about skills and competencies associated with those learning experiences, and generate a list of competencies and/or courses that are evaluated using a strength of fit analysis as candidates for granting PLA credit from the learning institution's catalog. System 100, given a list of competencies, may retrieve a list of summative assessments that can be used to validate those competencies. System 100, given a set of summative assessment evaluations, may produce a set of competencies that may be granted.

Typically, the PLA analysis and grant process is manual and subject to errors and delays. By automating the process, system 100 may ensure that skills, experience, and prior learning, both verified and unverified, are mapped accurately to competencies. These can be evaluated to grant the maximum amount of PLA credits and/or other credentials (including, but not limited to digital badges and certifications) to the learner, aligning the learner as closely as possible to suggested learning pathways 120.

Benefits of system 100 may include improved accuracy in the granting of PLA credits and increased learner motivation to start, persist, and pursue their goal outcomes. Benefits further include a reduction in time to complete a learning path by not requiring learners to spend time and money to pursue competencies they have already completed, and improved accuracy in the granting of PLA credits. Additionally, system 100 may provide a reduction in the administrative overhead for the learning institution to review and calculate credit transfers, allowing staff to focus on the granting of credentials and supporting students along learning pathways 120.

Recommendation engine 160 may accept input from skill service 102, profile service 190, PLA processing 154 (including PLA engine 152), and the learner profile 140 and uses AI/ML to generate one or more learning pathways 120 for the learner to consider in pursuit of their goal. Learning pathways 120 may be unique, personalized pathways based on the learner's prior experience and skills. For example, system 100 may recommend a sequence of learning experiences and assessments based on a specific learning goal (e.g., a skill, a job, a specific credential, etc.), the learner profile 140, and specific optimization criterion/criteria (e.g., time-based, financial, modality preference(s), etc.).

System 100 may use machine learning to generate a recommended sequence of learning experiences, assessments, and alternate learning goals—expressed in the form of personalized learning pathways 120—to guide learners based on a set of variables that establish their unique criteria and constraints. Recommendation engine 160 may use data from the learner profile 140 to build learning pathways 120 recommendations to suggest new learning experiences, resources and/or pathways for the learner's personalized learning plan. In some embodiments, recommendation engine 160 may continuously ingest and train on new data to refine the recommended learning pathways 120. In view of the foregoing, system 100 may reduce dependency on human interventions to interpret a learner's individual needs and circumstances to construct their personalized learning plan.

Recommendation engine 160 may recommend credentials for learners maintained within the credential and pathways service 170. Additionally, recommendation engine 160 may recommend alternate learning experiences and assessment options based on selected input variables and recommend alternate learning goals based on learner behavior and the goals of similar learners and associated pathways. Furthermore, recommendation engine 160 may recommend credentials from the learning institution's credit-bearing and noncredit-bearing offerings.

When considering and navigating through their learning journeys at a learning institution, learners may benefit from personalized guidance and recommendations in determining which learning pathways 120 and learning experiences to pursue, and in which order. System 100 may use AI/ML to provide personalized recommendations and guidance at scale, enabling more learners to pursue their goals.

Accordingly, system 100, may allow the learner to understand how their prior education, experience, and skills play a role in a potential learning journey with the learning institution that is personalized to accommodate these competencies. Additionally, system 100 may allow the learner to make smart and very personal decisions about whether the time and financial resources they have for investment in education are beneficial to them and provides a reduction in learner anxiety about whether their learning journey will be valuable to them. System 100 also may provide personalized experiences for all learners, but it may be particularly beneficial to those who may not be adept at navigating the cultures, structures, and processes of online higher education. Furthermore, system 100 may provide increased enrollment, driven by recommendations that take advantage of prior education, experiences, and skills, and more personalized learning pathways 120 to achieve goals in less time.

Credentials and pathways service 170 may store and manage metadata related to current credential offerings and established learning pathways 120. Metadata may be kept up to date so that it can be ingested and used by recommendation engine 160 to provide learners with accurate and current pathway and credential options, based on their goals and learner attributes. The metadata may be referenced by curriculum developers and learning engineers to expedite the development of curriculum and learning experiences that are aligned with learning pathways and credential options. Credentials and pathway service 170 may automatically ingest metadata concerning credentials and learning pathways 120 from both internal and external sources.

Metadata can be ingested from internal learning institution content and curriculum management systems. Additionally, metadata can be ingested from external services that offer credentials or sections of learning pathways 120.

Credentials and pathways service 170 may edit stored credentials and learning pathway objects with updated metadata. Changes can come from automated ingestion or manual user input. A changelog may be stored so that a previous version can be restored if needed.

A learner record store 180 is a collection of the learner's activity and experiences that allow accurate, personalized academic and staff support to be presented to the learner. Learner record store 180 records the results and the context of the learning, including but not limited to learner actions, behaviors, enrollments, progress, and outcomes.

Learner record store 180 may include data documenting progress through and/or completion of learning experiences generated by system 100 and previously completed work recognized through the PLA processing 154. This includes but is not limited to what was completed, when it was completed, scores received, etc. Additionally, learner record store 180 may include data from an application programming interface, such as xAPI, and an activity stream representing how a learner progressed through learning experiences. This may improve the learner's ability to select credential options that are relevant and current and retain learners in the ecosystem for related learning experiences by creating and suggesting additional learning pathways 120.

profile service 190 may align the learner's educational activity, including learner accomplishments and methods/modalities used to achieve them. Learner data is often stored in several locations and may be difficult to keep current, often forcing manual record updates and/or uploading documents. Profile service 190 may provide guidance on setting academic goals. Goals influence recommended learning pathways 120 to help learners work toward their learning outcomes.

Profile service 190 may include data on constraints and preferences, including factors that may affect or influence learner achievement and/or success. This includes, but is not limited to, time constraints (hours of day, days of week, time to credential, etc.), financial constraints, access to technical resources (such as a computer, high-speed internet, etc.), reliable transportation for onsite learning, a safe learning environment, food insecurity, etc.

Profile service 190 may take an analytical summary of behaviors and actions and, using AI/ML, engagement and learning events and activity data from the learner record store 180 to define learner attributes. Using that, profile service 190 may ascribe a level of proficiency for a student across the range of skills and competencies associated with a subject area. Examples of this data include but are not limited to, time to completion, academic difficulty, resources accessed/used, number of attempts, scores and grades, and actions related to learning and assessment objects, such as click patterns and behaviors.

Profile service 190 may also include readiness and so-called “sorting” diagnostics, such as diagnostics with analytical data models to determine proficiency level with skill and knowledge areas to calibrate the rigor of the learning experience, resource needs, etc., and diagnostics with analytical data models to determine a likelihood of success with various learning modalities. Profile service 190 may verify that an ingested record belongs to an established learner. Profile service 190 may also store a change log of updated records and may restore previous versions as needed. Furthermore, profile service 190 may push data to recommendation engine 160 to make recommendations.

Skill service 102 may use the skill repository 162 to compare learner-entered skills against the competencies offered via learning experiences in a learning institution's catalog. The mapping of skills may use AI/ML to determine matches so that competency “completion” may be considered based on classroom and professional experience, hours of work, metrics, and equivalencies, etc.

Aligning skills to competencies for credits or credentials has several challenges. When evaluating learner data, analysts have no easy way to reference skill-to-competency mapping to aid in improving learner outcomes. Analysts work with limited data for individual skill progressions, limiting their ability to suggest accurate skill mapping to content. Additionally, as learning content is being developed or updated, curriculum designers and learning experience engineers (LXE) must use manual processes to reference skill-to-competency mappings. This increases development time and the risk of error, which may result in inaccuracies in learning outcomes.

The alignment of skills to competencies in skill service 102 extends to learning objects, including content and assessments, to improve skill attainment and curriculum progression along learning pathways 120.

Skill service 102 may use internal and external data sources to construct skill-to-knowledge graphs using neural networks including skills, hierarchies, mappings to competencies, mapping to jobs data, and relationships. The skills may be ranked in a hierarchy to show how the skills are related to higher, more advanced skills within a group. Additionally, skill mapping may be utilized to show how the skills are related to higher competencies and knowledge. Both skills hierarchies and skills mapping may align to learning competencies, and the learning content needed to achieve those competencies.

Using rich skill descriptors as technical specifications of skills, skills may be mapped to employment data/job codes using existing schemas and services, such as, but not limited to CDTL, OSN, EMSI, and BurningGlass. Rich skill descriptors are machine-readable, searchable data that include the context behind a skill, giving users a common definition for a particular skill and helping make it understandable and transferable across the learning-earning landscape. The skills may also be mapped to the ability to create new competencies and skills, the ability to edit existing competencies and skills, and the ability to consume a comma-separated values (CSV) array of competencies and skills to create new objects, edit metadata/descriptions, and/or relationships. Additionally, the skills may be mapped to the ability to version instances of any given competency or skill, to view and report on any relationships between and among competencies, skills, and other curriculum objects, and to human-validated alignment informed by AI/ML-enabled strength of fit scores, graph analysis, etc.

Classroom experience 110 represents the collection of systems, learning experiences, data, policies, and interactions between a learner, advisor, and instructor that may lead to the completion of one or more competencies. Note that classroom experiences may be online or in-person, synchronous or asynchronous.

The learner dashboard may display available learning objects. Learners typically want engaging and modern learning experiences to match their expectations as they seek to obtain skills and competencies to improve their career marketability. Accordingly, displayed learning experiences may be pulled from enrolled courses and programs. Experiences display status (not started, completed, in progress, etc.), and program progress is displayed on the dashboard. A learning environment may display content that the learner has chosen from the dashboard.

An instructor experience 122 may represent a collection of systems, learning experiences, data, policies, and interactions between an instructor and a learner, as well as interactions between the instructor and the learner's support staff and the instructor and other academic staff, such as program leads and deans. Instructor experience 122 allows Instructors to support content, grading, advise, and communicate with learners.

A student experience and staff experience 132 may represent a collection of systems, data, policies, knowledge, and interactions between a learner and any member of the institution's support staff (including, but not limited to admission, academic advising, student financial aid, and career) to ensure the success of the learner in the pursuit of their goals.

Typically, the learning institution staff does not have access to such detailed data, and the data that is available is not stored in a centralized location. As such, it may not be possible to make customized, actionable recommendations for the learner at scale. In the pursuit of the highest quality student support, support staff want to answer learner questions accurately and efficiently so that learners get the answers they need to continue on their learning pathway.

The student experience and staff experience 132 may empower staff to support learners. For example, system 100 may provide a central location for support staff to access learner data so they may share accurate information quickly and with high satisfaction. Additionally, system 100 may provide learner attributes, goals, education, and employment history, interactions with curriculum/learning environment performance on assessments, completed work, grades, etc. to be accessed in the learner profile 140 based on the learner's permission sets. Additionally, system 100 may provide support staff with visibility into learning pathways 120 and progress in real time, and system 100 may provide support staff with the ability to override learning pathways 120 recommendations for a learner. Furthermore, system 100 may provide administrative visibility into PLA (applied for and granted) and provide support staff with visibility into and the ability to change learner account settings, preferences, login information, etc.

System 100 may use AI/ML and chatbot technology to “nudge” learners to take action. Nudges may be incorporated at various levels to complement the work of the learner-facing staff. For example, nudges may supply prompts to complete required fields during enrollment and onboarding, notifications to complete the required steps of a process, and short message service (SMS) alerts regarding incomplete and/or unsubmitted work, deadlines, important dates, etc. The nudges may also supply a digital assistant for routing inquiries to the correct support department, learner guidance to pathway choice, self-service for frequently asked questions, such as login issues, application form questions, financial aid form questions, deadlines, etc., and escalate to the correct department if unresolved.

System 100 may also collect data about learners to supply learning pathways 120 and recommendations. The learner profile 140 is the part of system 100 related to each specific learner. For example, the learner profile 140 may include identifying information, demographic data, learning goals, learner education, work experience, and skills, as well as interests and goals. Additionally, learner profile 140 may include learning preferences, learning constraints, learning behaviors, and preferred communication channels. Furthermore, the learner profile 140 may include academic progress via the classroom experience 110 (online or traditional), academic achievements (completed competencies, credentials, etc.), and interactions (all communications in all forms, tasks and their action items and results, with advisors (admission, academic, financial aid, career), instructors, and other digital-based delivery of information).

Currently, learning institution experiences tend to be “one size fits all.” Obtaining a full learner profile 140 allows the learning institution to supply learning pathways 120 and recommendations, improving the overall experience and increasing the achievement of positive learning outcomes for learners.

An analytic engine 150 may ingest data from all of system 100 components for analytical analysis and feedback. Summary data from the analysis may be pushed to the learner profile 140, so that learner attributes may ascribe the level of knowledge of skills and/or competencies and track achievements.

The analytic engine 150 may consult a learner record store 180, as well as internal and external data sources to recognize when a learner's learner profile 140 properties and attributes might need to be refreshed, such as when a learner completes learning pathways 120. The recognized activity in the learner record store 180 trigger the execution of analytical packages to determine if learner profile 140 updates are needed (such as when the last requirement for a competency was completed), posting any updates such as attainment of competency to the learner profile 140.

Learner behavior data, including analysis of learner data across applications and systems, may be used to monitor software performance and make improvements. Captured learner data may include, but is not limited to learner account level data, such as personal info, demographics, etc., learner activity, such as learning experiences started, completed, etc. (i.e., learning and assessment objects, including resources). Additionally, captured learner data may include a learner activity log, such as the date and time stamps for start, completed, and pause, term alignment, and geolocation for data entered by the learner, and other learner actions, such as resources used, number of attempts, alternative answers, skipped items, and outreach and/or engagement with support systems and/or resources. Furthermore, captured learner data may include learned behaviors, such as keyboard behavior, mouse behavior, time spent on specific pages, learning and/or assessment objects, resources, etc., bounce rates, user path, and clicking other tabs. Captured learner data may also include learner outcomes, such as scores and/or grades, rubric level assessment of the performance of specific criteria, as well as topline performance.

Learner data outside of learning experiences may also be captured and analyzed, including, but not limited to movement and progress through an acquisition funnel (conversation rates, velocity, melt, bottlenecks, etc.), application and/or enrollment data, and term starts, term-to-term persistence, withdrawals, etc. Admin level data capture and analytics, including all interactions that staff have in the management of any of these products to assess software performance, may also be collected.

A skill repository 162 may be utilized as a centralized storage solution for knowledge and skill maps aligned to competencies associated with learning experiences and credential pathways.

Knowledge and skill maps may be created and edited by skill service 102. Skill service 102 may include the mapping of external skills, job roles, and employers from databases such as SOC, O*Net, and/or other external markers by leveraging linked open data sources like EmsiBG and OpenSkills. This accessible and accurate information may aid in the development of the learning institution's curriculum, especially competencies and skills. Additionally, this alignment to workforce markers, like job roles, may allow products to be more immediately relevant in the workforce, increasing the utility of the offering for the learner when they apply for jobs. Accordingly, skill repository 162 may store and track competency and skill relationships, attributions, and version history.

The content developer experience 172 represents a collection of technologies, content and assessment objects, templates, syllabi, and interactions between content developers, subject matter experts, deans, and others to develop learning experiences, such as courses, for learners of system 100.

When creating content for learning experiences, learning experience engineers and subject matter experts may develop or source content efficiently and collaboratively, to minimize rework and errors and to shorten the time required to create content. Content developer experience 172 may improve scalability of content creation, reducing rework and cost of production. Additionally, the content developer experience 172 may improve re-usability of content objects, reducing learning object creation time, improving object history, and increasing job satisfaction for content and curriculum creation staff.

Content developer experience 172 also may allow learning experience engineers to author both automated and/or manually graded formative and summative assessments within the same authoring tool. For example, content developer experience 172 may allow learning experience engineers to create and deploy diverse types of rubrics that align with content objects that measure learner skills and competencies. This allows system 100 to capture and assess authentic learner data. Furthermore, the content development experience may allow learning experience engineers to easily identify, reuse, and edit existing formative assessments.

Content repository 182 may store individual objects and referenced objects, such as illustrations, videos, interactives, assessments, and text, which may be used in the creation of learning experiences, such as courses, modules in courses, and assessments for access by the learner. Content may be generated with the assistance of AI tools. Content developers may use content and assessment objects in content repository 182 in stackable, reusable, and scalable ways to create content that can be reused and repurposed in many learning experiences.

Content repository 182 may provide a learning experience engineer with a way to quickly and easily locate and update content objects, including assessments, so that content objects are always relevant, current, and align with the desired outcomes. This may reduce rework, time to completion, and errors while improving object tracking and improving learning outcomes through up-to-date content.

Content repository 182 may also allow for learning objects to be tagged with applicable skills metadata, and other searchable tags so that objects can be leveraged by all content creation staff and learning pathways 120. Furthermore, content repository 182 may allow assessment objects to be tagged to other content objects, increasing their reusability and ease of maintenance.

Curriculum developer experience 194 represents a collection of technologies, learning experiences, and interactions between content developers, curriculum developers, subject matter experts, deans, and others to create and update curriculum and maintain the accuracy of attributes and relationships of curriculum objects, such as credentials and degree programs, for learners using the system 100.

Curriculum developer experience 194 may include the development and staging of curriculum, and review, collaboration, and approvals throughout the curriculum design process. The curriculum manager's oversight of the entry and continuous maintenance of curriculum objects may also be included. Additionally, the curriculum designer's development of curriculum, managing the entry and maintenance of curriculum objects during development may be included in curriculum developer experience 194.

With curriculum developer experience 194, curriculum designers may add and edit new objects, specifically in the domain of development, including AI-generated content, and evaluate if existing curriculum objects meet the needs of current development. Additionally, curriculum reviewers may validate and provide feedback on development curriculum prior to approval, view, and comment on curriculum they are reviewing, and approve of curriculum.

Instructional designers designing learning experiences based on curriculum objects may use curriculum developer experience 194 to access curriculum objects (and related objects) to properly execute their design, for visualizations of curriculum for layout, sequencing, and attribution of curriculum objects, and for the ability to version instances of any given curriculum object.

A flexible metadata model of curriculum developer experience 194 allows for differentiation between different iterations of a given curriculum object, the ability to search for objects by primary metadata fields, including, but not limited to the type, owner, and code. Additionally, curriculum developer experience 194 may provide the ability to view and report on any relationships between and among curriculum objects, including, but not limited to credentials and learning opportunities. For example, some courses are connected to a single academic program, while others are offered across multiple programs. For another example, learning opportunities may differ across learning models. For yet another example, some pathways may result in a specific credential. Furthermore, objects in collections and the learning opportunities, pathways, and credentials they are affiliated with or connected to (e.g., data from collections comes from competencies and skills management) may benefit from the ability to view and report on any relationships. For example, competencies that are aligned to a given course, skills that are included within a given learning opportunity, and competencies that make up a given academic program.

A curriculum repository 192 may store and maintain attributes and relationships of curriculum objects, with credits/competencies, courses, and credential pathways. Just as individual content can be stacked and reused in a variety of learning experiences, the individual curriculum objects may be stacked and reused in many configurations or versioned for different learning outcomes and pathways, such as certifications and degree programs.

The curriculum repository 192 may automatically ingest metadata concerning credentials and learning pathways 120. The data can be sourced both internally (from the learning institution's content) and externally (from sources that offer content of credentials). Curriculum repository 192 may leverage several data standards that are used to represent curriculum, including CTDL, and IMS Global CASE. The metadata tagged to curriculum objects in the curriculum repository 192 may be searched and managed by curriculum developers. Additionally, the curriculum repository 192 may push approved curriculum to a credential repository 196.

The credential repository 196 may represent the “source of truth” of a learning institution's curriculum. The credential repository 196 may manage approved, governed curriculum. The credential repository 196 may house courses, competencies, programs, concentrations, experiences policies, proposals, agendas, and reports. Additionally, the credential repository 196 may store the relationships between approved curriculum, credits and competencies, courses, and credential pathways.

The credential repository 196 may allow a user to see the history and evolution of items, including all versions and changes that are tracked, easily viewable, and accessible in reports. Additionally, the credential repository 196 may manage and publish the learning institution's catalog.

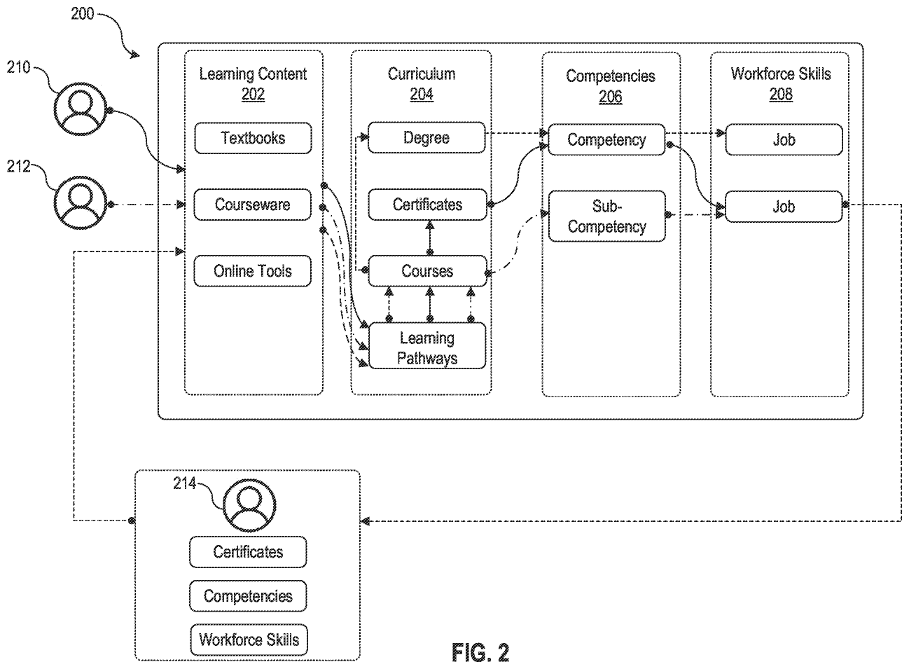

FIG. 2 illustrates a diagram of a system 200 showing a connection between learning content 202, curriculum 204, skills and competencies 206, and workforce skills 208 consistent with embodiments of the present disclosure. System 200 may create a customized and responsive learning pathway for student 210, student 212, and student 214. A customized path for each learner is shown. The path for student 210 is shown using solid lines, the path for student 212 is shown using lines with a dash-dot pattern, and the path for student 214 is shown using a dashed line.

System 200 may analyze information about student 210, student 212, and student 214 in developing a learner's customized and responsive learning pathway. In the illustrated embodiment, student 214 has acquired certificates, competencies, and workforce skills based on a job. System 200 may map these certificates, competencies, and skills to courses and competencies associated with a learning pathway. System 200 may map the existing certificates, competencies, and skills of student 214 to requirements associated with a specific course of study, and credit toward certificates and/or degrees may be awarded to streamline a customized learning pathway. In contrast, student 210 and student 212 may be starting their learning objectives without existing certificates, competencies, or workforce skills.

A variety of types of learning content 202 (e.g., textbooks, courseware, and online tools) may be offered to student 210, student 212, and student 214. The learning content 202 may provide the basis for various types of curriculum 204 that advance a learner's objectives. For example, some learners may pursue degrees and other students may pursue certificates. Further, some students may take courses to gain greater knowledge of a topic or to explore learning paths without the objective of obtaining a degree or a certificate. Learning content 202 may be customized for each of student 210, student 212, and student 214.

Curriculum 204 may be customized for student 210, student 212, and student 214 based on each learner's objective. The customized learning pathway for student 214, includes courses, certificates, and a degree. The customized learning pathway for student 210 includes courses and certificates. The customized pathway for student 212 includes only courses. The curriculum 204 may be customized for each learner based on the learner's unique learning pathway. Competencies 206 may relate to both practical and theoretical competencies based on each learner's objectives. Courses and certificates may develop and evidence proficiency in specific tasks or fields.

In the illustrated embodiment, student 214 acquired certificates in connection with a job. As such, the customized learning pathway for student 214 may include credit for the learner's certificates and enable student 214 to bypass certificates that would typically be associated with the learner's course of study. Awarding credit for certificates and workforce skills acquired at work may allow student 214 to progress more rapidly toward a degree than other learners who lack these certificates or skills.

Curriculum 204 develops a specific set of competencies 206 associated with a learner's objective. In the illustrated embodiment, a degree earned by student 214 and a certificate earned by student 210 may evidence a specific competency, and the courses completed by student 212 may evidence a specific sub-competency.

The development of specific competencies 206 may provide a learner an opportunity to develop workforce skills 208 corresponding to specific jobs. In the illustrated embodiment, the learning pathway for student 214 leads to a job that requires the certificates and degree earned and the competencies developed throughout the course of study. The learning pathway of student 210 and student 212 may lead to the same job.

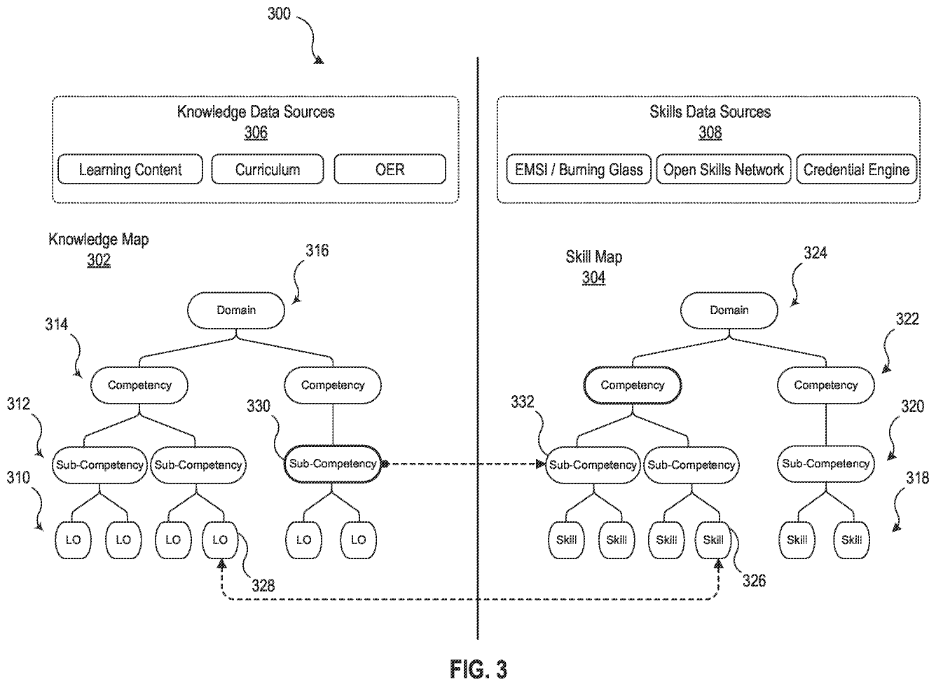

FIG. 3 illustrates a diagram 300 showing a connection between a knowledge map 302 and a skill map 304 consistent with embodiments of the present disclosure. Diagram 300 illustrates that specific knowledge may be associated with specific skills. Associating desired skills with knowledge may provide a way to customize learning for students that desire to obtain specific skills and/or translate skills into proven knowledge. A learning pathway of a user may be customized in various ways based on a learner's knowledge and skills in various embodiments consistent with the present disclosure.

Knowledge map 302 may be defined by knowledge data sources 306. Knowledge data sources 306 may include curriculum, textbooks, open education resources, etc. Knowledge map 302 may include a plurality of learning objects (LO) 310 at its base. The plurality of learning objects 310 may include courses, assessments, content, etc. associated with a particular topic. One or more learning objects 310 may be encompassed by a sub-competency 312. One or more sub-competencies may be associated with a competency 314. Finally, a domain 316 may be associated with a plurality of competencies.

Skill map 304 may be defined by skills data sources 308. Skill data sources 308 may include skills information from a variety of sources, such as EMSI/Burning Glass, Open Skills Network, Credential Engine, etc. Skill map 304 may include a plurality of skills 318 at its base. One or more skills may be encompassed by a sub-competency 320. One or more sub-competencies may be associated with a competency 322. Finally, a domain 324 may be associated with a plurality of competencies.

Various embodiments consistent with the present disclosure may associate specific skills (e.g., skill 326) with various learning objects (e.g., LO 328). In various embodiments consistent with the present disclosure, a learner may demonstrate mastery through the completion of a learning object or demonstration of a skill. Skills may be acquired in a variety of ways (e.g., on-the-job training), and a learner who possesses a specific skill may be permitted to bypass an associated learning object based on a demonstration of the skill. Similarly, other levels of competency may be established between knowledge map 302 and skill map 304.

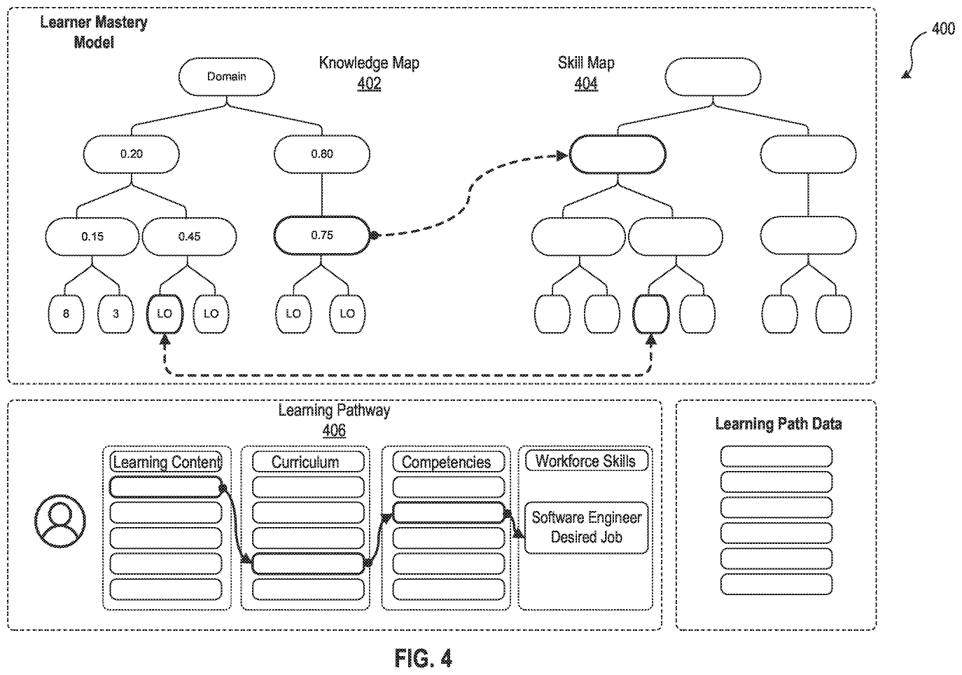

FIG. 4 illustrates a diagram 400 showing a personalized path of learning for a learner and seeking a specific job consistent with embodiments of the present disclosure. A learner with a particular knowledge graph and skill graph may be provided with a personalized path of learning that leads to a desired outcome. In the illustrated embodiment, the desired outcome is a job as a data scientist. The personalized path of learning may include the acquisition of knowledge and skills that provides the student with the knowledge and skills needed to succeed as a data scientist.

Diagram 400 may provide learners and educators with a representation showing a customized and responsive learning pathway. Diagram 400 may be updated as a learner makes progress toward a learning objective. In the illustrated embodiment, a knowledge map 402 includes indicators of completeness for certain learning objects, sub-competencies, and competencies. The indicators of completeness may be updated as the learner makes progress (e.g., completing a learning object). Various associations between knowledge map 402 and skill map 404 may be illustrated. Such an illustration may facilitate an understanding of how various learning objects, sub-competencies, and competencies are related to workforce skills associated with the learner's objective.

A learning pathway 406 may provide a graphical representation of specific learning content, curricula, and competencies that lead to the learner's objective, which is a specific job in the illustrated embodiment. The learning content may identify learning content (e.g., specific texts or other resources) the learner may utilize to master curricula. Mastery of the curricula develops competencies that translate into workforce skills associated with the learner's objective.

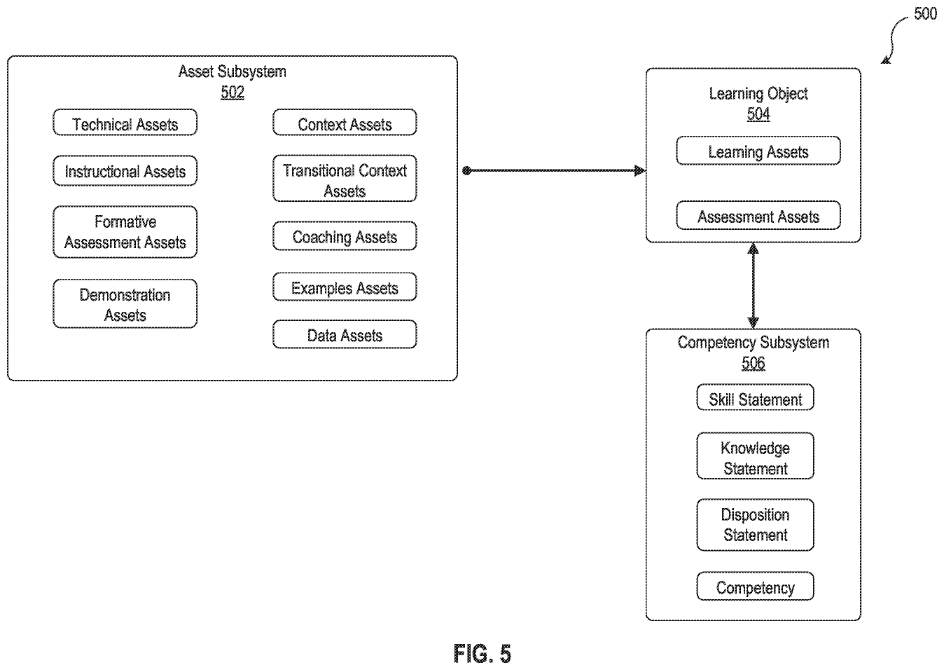

FIG. 5 illustrates a functional block diagram 500 showing information associated with a learning object consistent with embodiments of the present disclosure. A learning object 504 may be based on a plurality of assets provided by an asset subsystem 502. Asset subsystem 502 may include a variety of types of learning assets and assessment assets. The learning assets may include content that conveys information to a student related to the learning object 504. The assessment assets may provide a variety of evaluations for assessing a learner's mastery of the content.

A competency subsystem 506 may provide a variety of criteria against which an assessment may be compared. In some embodiments, the assessment assets may evaluate a learner's mastery of various competencies based on a plurality of rich skill descriptors. A threshold may be established for the user to satisfy the requirements associated with learning object 504.

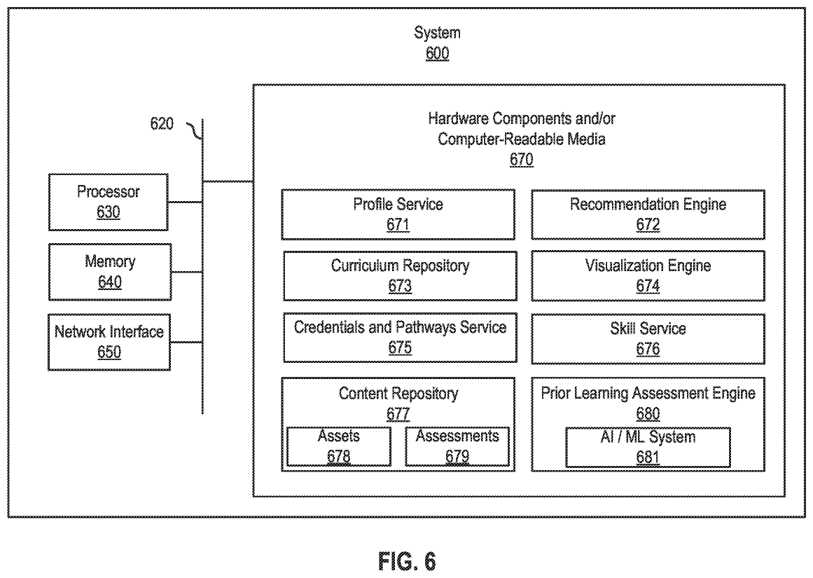

FIG. 6 illustrates a functional block diagram of a system 600 to deliver a customized and responsive learning pathway consistent with embodiments of the present disclosure. System 600 includes a processor 630, memory 640, network interface 650, and a computer-readable media 670. As one having skill in the art will appreciate, various elements illustrated as being encompassed by computer-readable media 670 may also be implemented using hardware components configured to implement the functionality described in connection with such elements. Computer-readable media 670 may include modules or subsystems and be connected to, for example, the processor 630 via a bus 620.

A profile service 671 may receive and track information about learners. Profile service 671 may receive a learner's goals or learning objectives. The learner's goals or learning objectives may relate to a course of study, obtaining workforce skills, earning certificates or degrees, etc. Profile service 671 may receive information to represent the student's prior learning related to the course of study and track a student's progress related to the course of study.

A recommendation engine 672 may generate a customized and responsive learning pathway for each learner. Recommendation engine 672 may generate a customized learning pathway based on a learner's course of study, a plurality of competencies and courses associated with the course of study, a learner's prior learning, and a variety of other factors.

A curriculum repository 673 may store and maintain attributes and relationships of curriculum objects, with credits/competencies, courses, and credential pathways. Just as individual content can be stacked and reused in a variety of learning experiences, the individual curriculum objects may be stacked and reused in many configurations or versioned for different learning outcomes and pathways, such as certifications and degree programs. Curriculum repository 673 may automatically ingest and process metadata concerning credentials and learning pathways. The metadata tagged to curriculum objects in curriculum repository 673 may be searched and managed by curriculum developers.

A visualization engine 674 may generate representations of learning pathways and progress toward learning objectives. For example, visualization engine 674 may generate a representation similar to what is illustrated in FIG. 4. Further, visualization engine 674 may generate the dashboards illustrated in FIG. 1.

A credentials and pathways service 675 may generate a personalized curriculum based on a learning pathway. The credentials and pathways service 675 may store and manage metadata related to current credential offerings. Metadata may be kept up to date so that it can be ingested and used by the recommendation engine 672 to provide learners with accurate and current pathway and credential options, based on their goals and learner attributes.

A skill service 676 may be utilized as a centralized storage solution for knowledge and skill maps aligned to competencies associated with learning experiences and credential pathways. Skill service 676 may include various associations between learning objects, skills, sub-competencies, and competencies, such as the associations illustrated in FIG. 3 and FIG. 4. Knowledge and skill maps may be created and edited by the skill service 676. The skill service may include the mapping of external skills, job roles, and employers from databases such as SOC, O*Net, and/or other external markers by leveraging linked open data sources like EmsiBG and OpenSkills. The skill service may store and track competency and skill relationships, attributions, and version history.

A content repository 677 may store educational assets 678 and assessments 679 associated with various courses, certificates, and degrees offered by an educational institution. Content repository 677 may comprise individual objects and referenced objects, such as illustrations, videos, interactives, assessments, and text, which may be used in the creation of learning experiences, such as courses, modules in courses, and assessments for access by the learner. Content may be generated with the assistance of AI and/or ML systems. In various embodiments, assets 678 and assessments 679 may include the assets, assessments, and competencies illustrated in FIG. 5.

A PLA engine 680 may evaluate the prior learning (e.g., skills, competencies, certificates, coursework, etc.) related to a learner's course of study. The PLA engine 680 may conduct a strength of fit analysis to align the assessment with a plurality of competencies and courses in a learning institution catalog and associated with the course of study. The PLA engine 680 may map at least one of the plurality of competencies and courses to the assessment and grant a credit for the at least one of the plurality of competencies and courses. PLA engine 681 may include an AI or ML system 681 to perform the strength of fit analysis. Although the AI/ML system 681 is illustrated in connection with PLA engine 680, it may also operate in conjunction with other components of system 600.

While specific embodiments and applications of the disclosure have been illustrated and described, it is to be understood that the disclosure is not limited to the precise configurations and components disclosed herein. Accordingly, many changes may be made to the details of the above-described embodiments without departing from the underlying principles of this disclosure. The scope of the present invention should, therefore, be determined only by the following claims.

What is claimed is:

1. A system to deliver a customized and responsive learning pathway, the system comprising:
a profile service to:
receive an objective related to a course of study;
receive information to represent prior learning related to the course of study; and
track progress related to the course of study;
a prior learning assessment (PLA) engine to:
conduct an assessment based on the prior learning related to the course of study;
conduct a strength of fit analysis to align the assessment with a plurality of competencies and courses in a learning institution catalog and associated with the course of study;
map at least one of the plurality of competencies and courses to the assessment; and
grant a credit for the at least one of the plurality of competencies and courses based on the assessment; and
a recommendation engine to:
generate at least one learning pathway based on the credit granted by the PLA engine, the course of study, and the plurality of competencies and courses associated with the course of study.

2. The system of claim 1, wherein the PLA engine comprises one of an artificial intelligence system and a machine learning system.

3. The system of claim 1, wherein the PLA engine is configured to analyze at least one of a transcript, an articulation agreement, and prior work experience.

4. The system of claim 1, further comprising a curriculum repository to store the plurality of competencies and courses associated with the course of study.

5. The system of claim 1, further comprising a visualization engine to generate a visualization of the at least one learning pathway.

6. The system of claim 5, wherein the visualization comprises a directed acyclic graph.

7. The system of claim 1, wherein the recommendation engine is further configured to revise the at least one learning pathway based on an updated student goal.

8. The system of claim 1, further comprising a credentials and pathways service to generate a personalized curriculum based on the at least one learning pathway.

9. The system of claim 1, wherein prior learning related to the course of study comprises a plurality of rich skill descriptors and the PLA engine utilizes the plurality of rich skill descriptors to conduct the strength of fit analysis.

10. The system of claim 1, wherein the PLA engine is configured to operate without user intervention.

11. A method of delivering a customized and responsive learning pathway, comprising:
receiving, using a profile service, an objective related to a course of study;
receiving, using the profile service, information to represent prior learning related to the course of study;
tracking, using the profile service, progress related to the course of study;
conducting, using a prior learning assessment (PLA) engine, an assessment based on the prior learning related to the course of study;
conducting, using the PLA engine, a strength of fit analysis to align the assessment with a plurality of competencies and courses in a learning institution catalog and associated with the course of study;
mapping, using the PLA engine, at least one of the plurality of competencies and courses to the assessment;
granting, using the PLA engine, a credit for the at least one of the plurality of competencies and courses based on the assessment; and
generating, using a recommendation engine, at least one learning pathway based on the credit granted by the PLA engine, the course of study, and the plurality of competencies and courses associated with the course of study.

12. The method of claim 11, wherein the PLA engine comprises one of an artificial intelligence system and a machine learning system.

13. The method of claim 11, further comprising analyzing, using the PLA engine, at least one of a transcript, an articulation agreement, and prior work experience.

14. The method of claim 11, further comprising storing, using a curriculum repository, the plurality of competencies and courses associated with the course of study.

15. The method of claim 11, further comprising generating, using a visualization engine, a visualization of the at least one learning pathway.

16. The method of claim 15, wherein the visualization comprises a directed acyclic graph.

17. The method of claim 11, further comprising revising, using the recommendation engine, the at least one learning pathway based on an updated student goal.

18. The method of claim 11, further comprising generating, using a credentials and pathways service, personalized curriculum based on the at least one learning pathway.

19. The method of claim 11, wherein prior learning related to the course of study comprises a plurality of rich skill descriptors and the PLA engine utilizes the plurality of rich skill descriptors to conduct the strength of fit analysis.

20. The method of claim 11, further comprising operating the PLA engine without user intervention.
